(19) United States
(12) Patent Application Publication
(10) Pub. No.: US 2015/0194032 A1
(43) Pub. Date: Jul. 9, 2015

(54) WELLBEING MONITOR

(71) Applicant: I-SAISO INC., Raleigh, NC (US)

(72) Inventor: Raymond WRIGHT, Raleigh, NC (US)

(21) Appl. No.: 14/590,577

(22) Filed: Jan. 6, 2015

Related U.S. Application Data
(60) Provisional application No. 61/923,808, filed on Jan. 6, 2014.

(51) Int. Cl. G08B 21/02; G08B 25/01

(52) U.S. Cl. CPC G08B 21/02; G08B 25/016

(57) ABSTRACT

The present disclosure describes an interactive system for two-way “people” monitoring, messaging and alerting, especially of those who may need monitoring, such as elderly, young, the physically challenged or mentally challenged individuals. An application may be employed where the individual should check into the application periodically and if a check-in point is missed, an alert is generated for a remote user to check on that individual.

### CROSS-REFERENCE TO RELATED APPLICATION

This application claims the benefit of priority to U.S. Provisional Application No. 61/923,808, filed on Jan. 6, 2014, which is herein incorporated by reference in its entirety.

### BACKGROUND

It has always been difficult for those who are concerned, yet geographically remote from a family member to monitor the wellbeing of that family member. Seniors aging in place, wanting to remain in their own homes for as long as their health allows, could be forced to give up their independence to move in with family or to a managed residential property to give their families peace of mind that their wellbeing was not subject to unknown circumstances, incidents or gradual deterioration over time. Seniors are even more vulnerable in the hours or days between routine communications between family members. If an unexpected event such as a fall occurred during this time between communications, the senior in question faced considerable danger and even death in the most extreme cases, if left unattended and injured during this time. Similar concerns exist for those who are physically handicapped.

Existing “panic button” technologies simply do not allow for the notification of family members in such situations if the senior individual is unable to reach or use the technology due to a fall or other illness or incapacity. Anxieties surrounding these situations are considerable for family members. The subject of day-to-day wellbeing can be difficult to broach for some independent seniors, even with their own family members due to a fear of being judged, losing privacy, being watched via camera-based monitoring or generally not being in control of their own wellbeing. Conversely, the subject of day-to-day wellbeing can dominate and blight family relationships where family members rely on check-listing their loved one during phone calls for the sake of efficiency.

### SUMMARY

Embodiments of this disclosure include methods and systems for informing families of when scheduled lifestyle events happen, and more importantly, when they do not happen as expected. This provides around-the-clock reassurance for independent living seniors and their families, regardless of their location.

For example, the present disclosure describes an interactive system for two-way “people” monitoring via messaging and alerting, especially of those who may need monitoring, such as elderly, young, physically challenged or mentally challenged individuals. An application may be employed where the individual should check into the application periodically and if a check-in point is missed, an alert is generated for a remote user to check on that individual.

The disclosed wellbeing monitor is for families where the wellbeing of a loved one, usually of advancing age, is a concern and requires additional attention without specialist or on-site care, and without compromising the independence or usual daily routine the loved one is used to and enjoys. Busy working lives, commitments to other family members, different locations and even well-meaning but too frequent phone calls can all take their toll on families. A service to monitor wellbeing provides a simple, inexpensive way for families to achieve peace of mind by giving their loved ones additional, remote support.

In one embodiment, a service and process to monitor the wellbeing of others provides an easy-to-use, one-on-one, system of management and communication for professional caregivers who are supporting the wellbeing of one or more patients. An administrator receives notification of when the user's (patient's) day-to-day activities are carried out as expected and are alerted when they are not so the administrator can respond immediately in these instances and at any time should the user should request emergency help.

The solution presented herein is easy to set up, configure and manage through an internet ecommerce website. The ecommerce website can provide the managing user (the “administrator”) with the ability to add, change, delete, and suspend a monitored user's profile. Additionally, the solution allows easy payments through the ecommerce website.

The solution may be an interactive, two-way cloud-based “app” application solution for people (using a platform such as Apple®, Google®, Microsoft®, or other) or may be an interactive, two-way smart phone/tablet solution/wearable device for people (e.g., Apple®, Google® and Microsoft®).

The solution herein is both flexible and “mobile,” as the solution is application (“app”)-based for mobile/smart/wearable devices.

It will work anyplace, anytime worldwide using internet technology as the vehicle of communications. Worldwide time zones have been built in to accommodate administrators and users in different time zone locations.

### BRIEF DESCRIPTION OF THE DRAWINGS

Aspects of the present invention are further described in the detailed description which follows in reference to the noted plurality of drawings by way of non-limiting examples of embodiments of the present disclosure in which like reference numerals represent similar parts throughout the several views of the drawings and wherein:

FIG. 1 is a flowchart of an example of a method for creating, modifying and maintaining digital identities for users to which data can be correctly assigned and ownership established by way of a personalized digital “account” or record in accordance with an embodiment.

FIG. 2 is a flowchart of an example of a method for a user front-end interface process to communicate various states of current wellbeing, respond to scheduled event prompts or instigate video teleconference directly with an associated administrator in accordance with another embodiment.

FIG. 3 is a flowchart of an example of a method for an administrator to carry out monitoring processes for the wellbeing of their associated users in accordance with another embodiment.

FIG. 4 is a flowchart of an example of a method for a non-event notification process using three separate bearer technologies (Push, email, SMS) for notification delivery in accordance with another embodiment.

FIG. 5 is a flowchart of the hardware systems environment in accordance with another embodiment.

### DETAILED DESCRIPTION OF THE EMBODIMENTS

Embodiments will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Like numbers refer to like elements throughout.

It should be understood that the terms “administrator” and “user” are used herein to define and distinguish the two central types of users of the invention in their broadest sense. This does not preclude these roles from having a consumer or family-centric application, or one that exists in a professional care environment. Similarly, references to senior wellbeing could and should extend to the wellbeing of any individual user, regardless of their age.

Embodiments of this invention relate to the system and method of real-time, secure, two-way communications, storage, scheduling, recording and reporting of pre-defined status conditions (“events”) of an individual user (or multiple individual users) to a known but remote administrator. User and administrator interfaces may be established via applications on their preferred mobile devices (e.g., a phone or tablet). Data resulting from use of the app by both the user and the administrator is transferred via IP and is hosted in “the cloud.” VOIP and standard device-embedded telecommunications technologies (so-called “bearer technologies”) are employed for direct communications between the user and the administrator. Automation may be used for monitoring user responses. Subsequent alerts and escalating procedures (e.g., to the cloud for reporting and to alternate contact channels of the administrator, namely email and SMS) can be issued following a lack of response at a defined time to provoke a user or administrator's soonest response. Primary embodiments will be for the purposes of monitoring routine lifestyle events that pertain to the user's wellbeing by a nominated family or friend or care professional. Further embodiments can be used in various managed care environments (e.g., residential and assisted-living accommodation) and for generic administration applications where events instead pertain to defined tasks.

In one embodiment, a wellbeing monitor includes an automated software service (back end), ecommerce-enabled website and mobile application (front end). It allows individuals (users and administrators) to connect and communicate about the user's day-to-day scheduled lifestyle events for the purposes of remote wellbeing management.

Each user has the capability of indicating their status as either available or unavailable by turning on or off different status indications. For example, the user's interface may include a profile with a real-time indication of the following 2 important status conditions:

(i) I'm Napping

(ii) I'm Out

Other status indications may be included that similarly indicate that the user is unavailable to respond. Each user has a schedule of routine daily events that are anticipated to take place at certain times. Examples of these simple events include the user being awake and out of bed in the morning, having taken their scheduled medication or having completed their daily exercise. The user is prompted to confirm when an event has taken place. The app will typically display one simple question at any given time—for example, “Are you up?” The user will either confirm yes, (which sends an event notification to the administrator's app) or not answer at all. If the user does not respond by a predetermined time, the user's failure to respond will trigger, via the cloud rather than the device, a non-event notification to the administrator's app. In some instances, the user might respond no. For example, the user might respond by indicating that they have not yet taken their scheduled medicine. In this case, the user can be prompted again at a later time to confirm that the event has been completed.

The user's response may be relayed by a simple one-touch button, or by selecting the appropriate response from a drop-down menu. The user may also contact their administrator from the app interface by using one-button selection. For example, the user might select from among the following options:

Emergency button (requesting urgent help)

Skype

FaceTime (iOS)

The administrator can use the app to select which user's profile to manage. After making their selection, they can review the current status of the user's profile (for example, in an “Activity” mode) or modify the user's event sequence (for example, in a “Manage” mode).

In Activity mode, the administrator can see the user's profile and current status (e.g., Available, Unavailable (due to either a Napping or Out status). The user's profile and status may be displayed together with a dashboard providing a summary of events. The dashboard can use various indicators to illustrate the status for each event. For example, the dashboard might use a traffic light system to indicate the status for each event. For scheduled events that have been confirmed by the user as expected, a green symbol is shown. For events in progress, an amber symbol is indicated, and for events that have not been confirmed by the user as expected, a red symbol is shown. Other methods include using strikethrough or graying out of text to indicate that an event has been completed, or indicating completed events by check mark or an “X.” Different symbols can be used to further differentiate between completed events and events in progress (for example, a “tick” mark for completed events, a “minus” symbol for events in progress, and a “cross” symbol for unconfirmed events). The completion time can also be indicated by time stamp. Likewise, a time can be displayed for an unconfirmed event indicating how long past due the event is.

In Manage mode, the administrator can see the user's profile, current status and other options for modifying the user's pending events. For example, the administrator can choose from:

Create new event

Edit existing event

Having made their selection, the administrator then chooses an event (e.g., from a scrollable list or by keyword search) and then assigns a scheduled time, similar to how an alarm is set on a phone. The administrator then selects which alerts will accompany this event. For example, the administrator can elect to have the alarm sent by phone call, email, or SMS notification, and can enter their choice of email address(es) or phone number(s).

An administrator may sign up for the service via the ecommerce website where they can select a suitable service package. Suitable packages may include a monthly subscription in which payment is automated on a monthly basis for as long as the administrator continues to use the service. The selected package will determine how many users the administrator, and the level of functionality they receive. At a minimum, they will add one user to their account. The set up of the account identifies the administrator's profile and associated user(s) profile(s) that relate to this account. The administrator can manage user accounts via the website or via the mobile application.

Both the administrator and the user can download the mobile application onto their respective devices (smartphone or tablet).

The mobile application has two distinct sets of functionality—one for the user, the other for the administrator. Individuals can select their respective roles of “User” or “Administrator.”

The administrator creates a profile for the user and then a schedule of timed daily events for the user using the Manage option. In all likeliness, this will be done following a real-world consultation with the user, to ensure it is in-line with the level of monitoring the user's wellbeing requires, and to ensure their prior consent has been given.

The wellbeing monitor is useful for families where the wellbeing of a loved one, usually of advancing age, is a concern and requires additional attention without specialist or on-site care. The wellbeing monitor provides this attention without compromising the independence or usual daily routine the loved one is used to and enjoys.

For many elderly people, there is a time where their wellbeing would benefit from additional care but does not yet require that care to take the form of on-site support from either family members or professional caregivers. Indeed, their ability to manage their own lifestyle without hands-on assistance is integral to their sense of independence, confidence and overall wellbeing. For families, especially those who are geographically distanced, a reliable system for monitoring the wellbeing of a loved one provides at-a-glance reassurance that their loved one is fine and well, and the peace of mind that should routines alter or their loved one need assistance, there is a reliable system in place that will alert them to this immediately, even if their loved one can't. With such a system running in the background, families can be unburdened by the topic of day-to-day wellness which can quickly dominate and monopolize conversations and be the primary reason for visits, phone calls etc., and can instead spend their time enjoying one another's company, just as they always have.

Professional caregivers and those operating in managed care environments have the same benefits as families but can also extend this to a group of patients/users in their care. This allows them to manage their time more effectively and provide additional support to patients when those patients need it rather than impose a schedule of care/checking up that does not necessarily suit the requirements of the patient's lifestyle. The historical recording of the patient's wellbeing also allows the administrator to see trends or patterns of behavior (for example, the patient may be sleeping longer than anticipated over a period of time) that warrants a discussion about beneficial lifestyle adjustments with the patient when their needs might change.

The acquisition of other independently generated data pertaining to the “quantified self,” such as biometric readings or other measurable or quantifiable indicators of health or wellbeing, may be integrated into the app. The monitor could also include sensors linked to household objects (e.g., a fire alarm, front door, television set, shower etc.) confirming when these features are used/set off and for how long in each instance, together with all the same alerts and escalation procedures provided to administrators for their response. This will extend the application's benefits to those users with more specific needs and/or disabilities and provide a wealth of archived personal data regarding an individual's wellbeing.

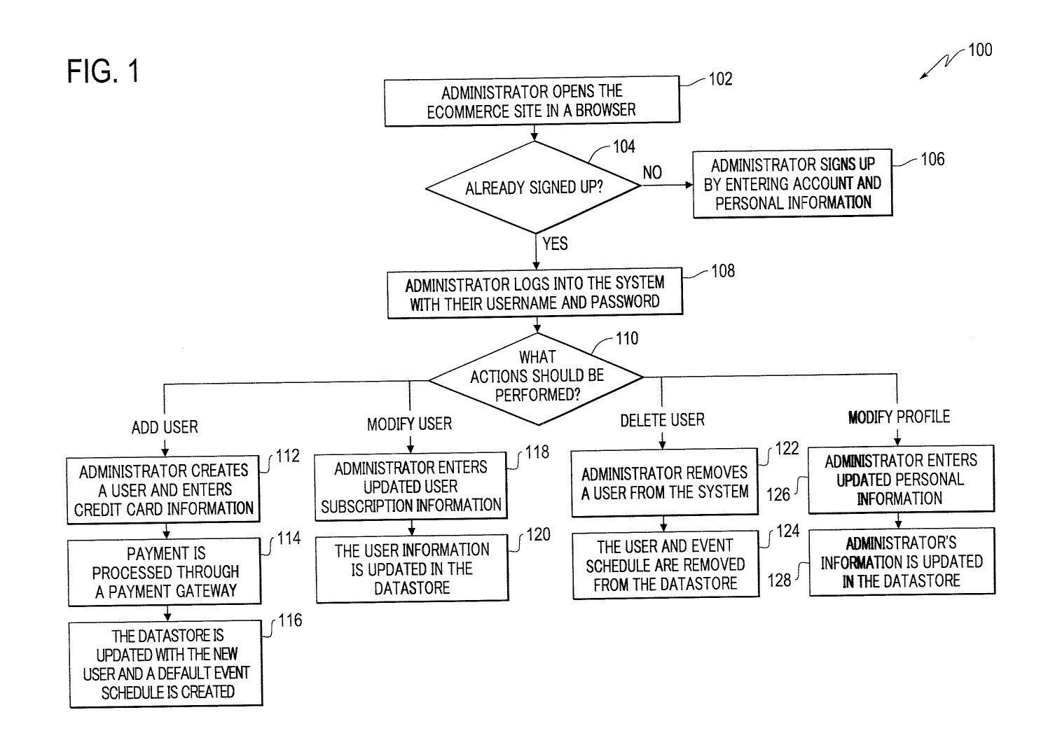

Some embodiments of the above are discussed below with regard to FIGS. 1-5.

FIG. 1 is a flow diagram illustrating a high-level method 100 of establishing, managing and maintaining digital identities of a single primary user or multiple users, by a primary or central administrator. It should be noted that the interface to such a method is typically accessed via a website from a computer, or other mobile, internet-enabled device such as a phone, tablet, or wearable device. However, the method may be accessed through embedded technology in sensor-centric or touch screen enabled surfaces or devices, either built in to a static location (in a domestic home setting, for example) or on another type of portable device or object (for example, a vehicle). For this process, the user plays no active part; the administrator carries out the entire process. The administrator utilizes a standard internet browser on their computer or other connected device to invoke a new session 102 on the dedicated ecommerce platform. As represented by the decision block in 104, a determination is made following a prompt to the administrator asking whether or not he is already signed up. This determines whether or not existing data, records and a digital account already exists for the administrator. The administrator has two options: Yes or No. If the administrator selects No, he is directed to create a new administrator account 106 by entering personal details. Once the account is created, the administrator may later log in as a returning user using a pre-registered username and associated password established during creation of the account. If however at decision block 104 he selects Yes, indicating he has already signed up, he will be able to access his existing digital identity, and associated account, data and records to perform various actions. The administrator does this by logging into the system 108 and identifying himself by using a pre-registered username and associated password. Having done so, the administrator is now presented with several options for actions he can take as shown in decision block 110. The actions are to add, modify, or delete a user, or to modify a profile. Each potential course of action following decision block 110 is described below.

At decision block 110, if the administrator decides he wants to add a user, he creates a digital profile for that user giving an associated user name and other details as shown in block 112. He also enters payment details such as his credit card information and preferred payment details for automatic monthly billing once the account is live. These payments are processed through a payment gateway 114 using the details the administrator has supplied in 112. Information supplied about the user from 112 and associated information on the payment details are then sent 116 to the datastore, which is updated with the new user data. This triggers a default event schedule for the administrator to use and modify for that user as required.

At decision block 110, if the administrator decides he wants to modify the details of a user, he nominates a specific user 118 and enters updated user subscription information. This new modified information about that user is sent 120 to the datastore where it is updated.

At decision block 110, if the administrator decides he wants to delete a user, for example if the user has passed away or has otherwise indicated that he no longer requires the service for any reason, the administrator removes the user profile from the system 122. Doing so will cause the same user profile and associated event schedule to be automatically removed from the datastore 124.

At decision block 110, if the administrator decides he wants to modify his own profile, for example to update his contact details, he selects the option to edit 126 and enters his new personal information. This newly created data on the administrator is then sent 128 to the datastore where his records are updated.

The above are just a few of the options for basic management of administrator and user digital profiles and accounts, and the processes involved for a person in the role of administrator to carry out such management and maintenance of the digital records in their charge for the new and existing persons (users) in their care.

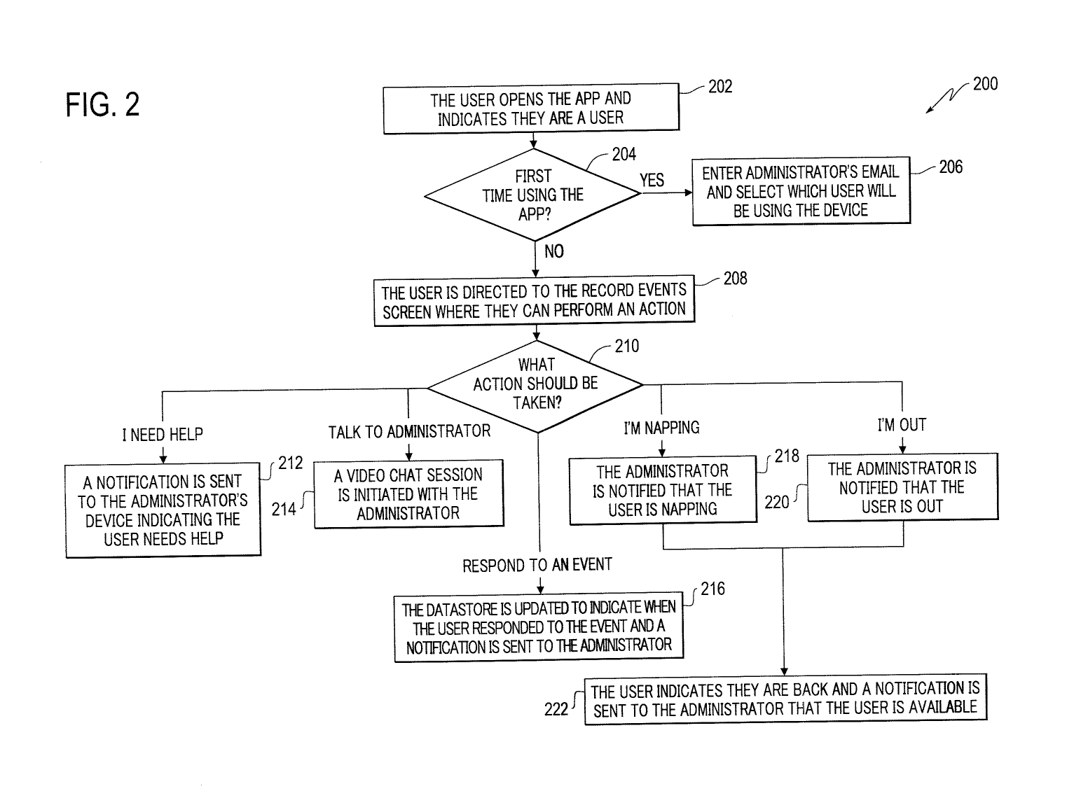

FIG. 2 is a method for the user to communicate via an interface 200 various states of wellbeing and spontaneously invoked status conditions, as well as the method to respond to scheduled daily events, and to invoke a real-time video call to the administrator. These actions are for the benefit of the administrator's understanding as to the user's current state of wellbeing. The interface may be an application run on a mobile, internet-enabled device such as a phone or tablet, or could exist in other forms as embedded technology in sensor-centric or touch screen enabled surfaces or devices, either built in to a static location (in a domestic home setting, for example) or on another type of portable device or object (for example, a vehicle).

In block 202, the user opens the application on their preferred mobile device. She is prompted to indicate whether she is a user or an administrator. In this instance, she chooses the button marked User. As indicated in decision block 204, a determination is made as to whether or not she is a new user. She has the option to select Yes or No. If she selects Yes, she must identify and link her profile. This can be accomplished by entering the administrator's email address as shown in block 206, and by identifying which user she is from the profiles shown. This action links the user and administrator processes so that they may be run from the same app, albeit separately and on different devices. At decision block 204, if the user selects No to indicate she is a returning user and this is not the first time she has used the app, she will be directed to the record events screen 208 where she has the option to perform several actions. For example, the user can submit a request (“I Need Help”); instigate a video chat session with her administrator (“Talk to Administrator”); respond to a scheduled event (“Respond to an Event”); or update one of her possible status indications, such as “I'm Out” or “I'm Napping.” Each potential course of action following decision block 210 is described below.

At decision block 210, if the user decides she needs help and wants to let her administrator know this is an urgent or emergency request, typically as a result of feeling unwell, sustaining an injury, or being frightened or otherwise vulnerable to her current circumstances, the user presses the “I Need Help” button at the top of their app interface on her device. This triggers a notification 212 directly to her administrator indicating her need for urgent assistance.

At decision block 210, if the user decides she wants to instigate a video call with her administrator, thereby making use of the “Talk to Administrator” option, she can do so as shown in 214 by starting a video call. This option would open a video conferencing session via any video conference or video-based telecommunications program or application loaded or embedded on her device (or vehicle, or other object loaded with the application). Possible video-based telecommunications programs include Skype® or Facetime®.

At decision bock 210, if the user decides she want to respond to a scheduled event, she simply confirms her completion of it via the app interface prompt. This sends her confirmation response 216 to the datastore indicating when the user responded to the event, and a subsequent notification is sent to her administrator. This particular process is the same for every scheduled event the user may have throughout the day and evening, according to her particular needs, plan and daily routine. As such, it is a central activity on the user's part.

At decision block 210, if the user decides to indicate that she is about to take a nap, she selects the “I'm Napping” indicator via the app interface. She can do this at any point regardless of the scheduled events that may be occurring during this time. Doing so sends a notification 218 of the user's change of status, from available in typical mode, to Napping, on her administrator's status indication for that user. When the user has finished her nap, she changes her status back to available as in block 222 which sends a new notification to the administrator of the user's availability. A notification may also be sent to the administrator if the user's status has remained “unavailable” for longer than a predetermined time (for example, if the user status is “I'm napping” for longer than 15 hours).

At decision block 210, if the user decides to indicate that she is about to go out, she selects the “I'm Out” indicator via the app interface. As with the “I'm Napping” function, selecting the “I'm Out” status indicator will send the administrator a notification of the user's new status as seen in block 220. As before, this lets the administrator know the user is temporarily unavailable. When the user returns and indicates she is back, a notification is sent to her administrator 222 to confirm the user is now available.

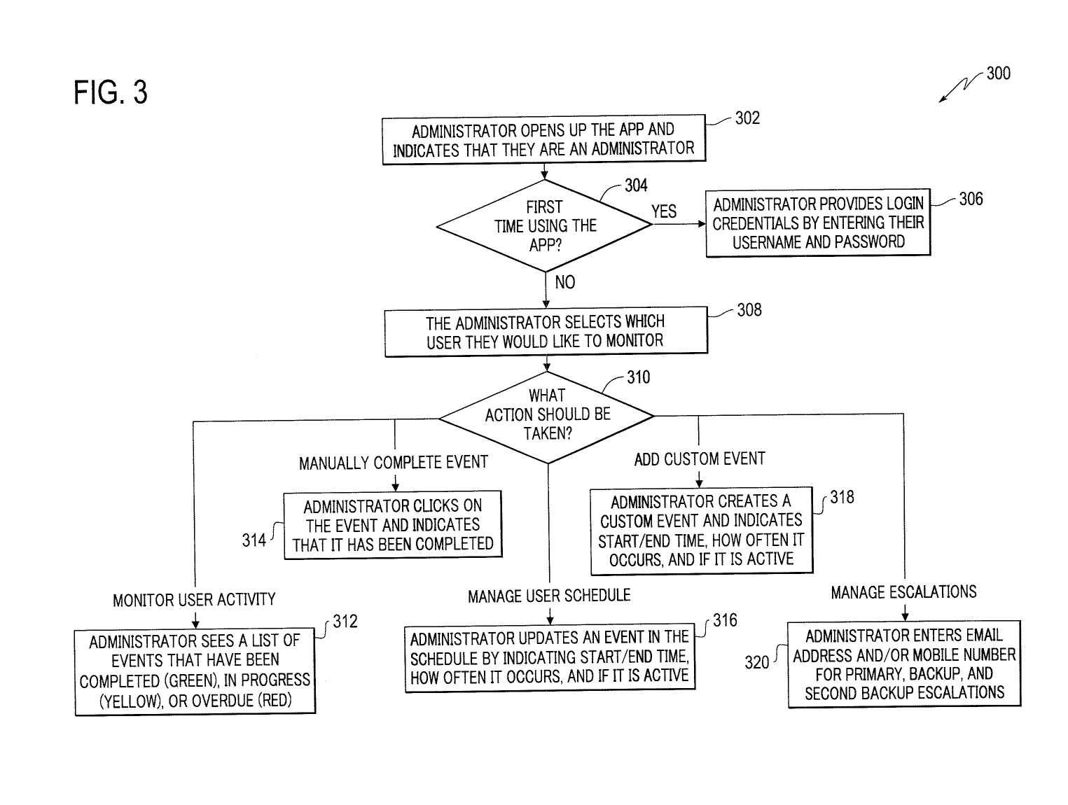

FIG. 3 is a flowchart of a method for carrying out monitoring processes 300 as an administrator to determine the ongoing wellbeing conditions and statuses of nominated users in the administrator's care. The interface may be an application run on a mobile, internet-enabled device such as a phone or tablet, or could exist in other forms as embedded technology in sensor-centric or touch screen enabled surfaces or devices, either built in to a static location (in a domestic home setting, for example) or on another type of portable device or object (for example, a vehicle).

In block 302, the administrator opens the app on their preferred mobile device. He is prompted to indicate whether he is a user or an administrator. In this instance, he chooses the button marked Administrator. As indicated in decision block 304, a determination is made as to whether or not he is a new administrator, using the app for the first time. He has the option to select Yes or No. If he selects Yes, he must then enter his login credentials as shown in block 306 by entering his username and password. At decision block 304, if he selects No, to indicate he is a returning administrator and this is not the first time he has used the app, he will be directed to indicate which user he would like to monitor 308. Having selected a user as per block 308, the administrator must determine which next action to take as indicated by decision block 310. At this juncture, the administrator has the option to perform several actions. Possible actions include monitoring user activity, manually completing an event, managing a user schedule, adding a custom event, and managing escalations. Each potential course of action following decision block 310 is described below. It should be noted that this range of options is not exhaustive, and additional options may be included for more detailed monitoring, management and reporting functionality to name a few. The ability to access all options will depend on the level of service package the administrator has selected, subscribed to or otherwise paid for.

At decision block 310, the administrator may decide to monitor user activity. This is a function for anyone in the role of administrator. When selecting this option, the administrator sees a list of the scheduled events and their respective statuses, as in block 312. Here, completed events are indicated with a green tick symbol. Events that are in progress are indicated as an amber minus symbol. Events that are overdue and have not yet received a response from the associated user are indicated with a red cross symbol.

At decision block 310, if the administrator decides he wants to manually complete an event on behalf of a user who has failed to do, so he can select the event as at block 314 and indicate that the event has been completed. Typically, the administrator would not use this function unless he had first been in contact with the user to determine first-hand that the event had in fact been completed but the user had overlooked responding to it. Thus, the circumstances will generally be benign in nature, rather than an indication of the user's inability to answer due to a lack of wellbeing.

At decision block 310, if the administrator decides he wants to manage the schedule of his nominated user, he selects the schedule in question as in block 316 and updates an event in the schedule by indicating the start/end time, the frequency of occurrence and if this event is in active status. This allows the administrator to modify events as required on behalf of his user as the user's requirements or lifestyle changes.

At decision block 310, if the administrator decides he wants to add a custom event for his nominated user, he selects this function and creates a new custom event as at block 318. As part of this process, he will identify the type of event and indicate a start/end time for it, determine the frequency of the event and whether it is deemed to be in active status. The ability to add custom events may be reserved for the highest levels of service, as this offers the most flexibility and allows administrators to very carefully personalize the user's schedule according to very specific events. These events could include lifestyle factors such as walking or feeding a pet, or health-related events such as specialist medical appointments following a surgery or illness as part of a program of recuperation.

If the administrator decides at decision block 310 that he wants to manage the escalation alerts for a user generated when an event does not receive a response from the user in the designated timeframe, he can manage or modify these escalations. As shown in block 320, the administrator can enter email addresses and/or mobile numbers for a nominated primary, secondary or tertiary nominees who typically would be other family members of the user, or in the case of a professional care service or environment, other care professional colleagues.

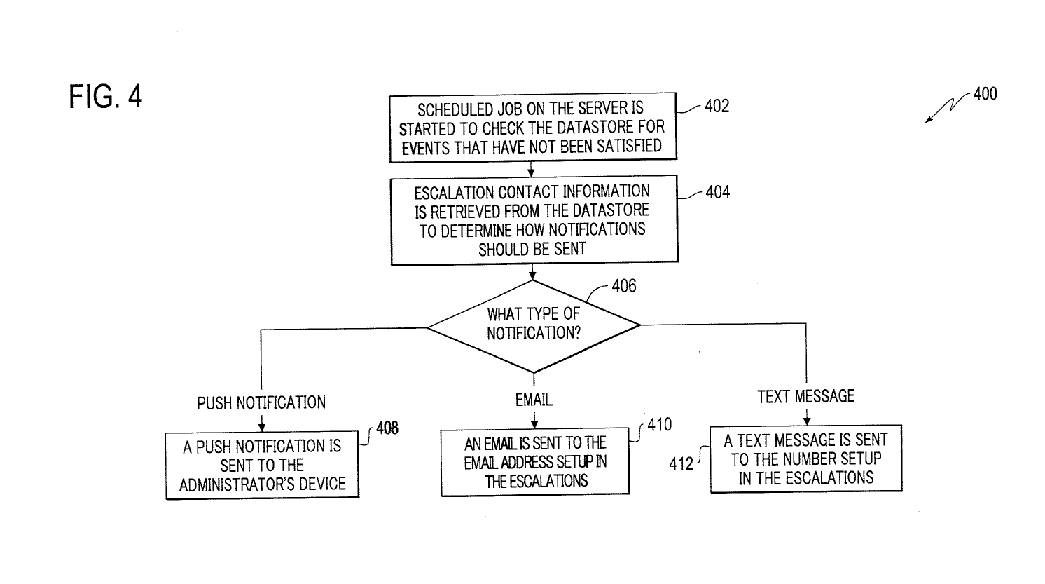

FIG. 4 is a flowchart of a method for a non-event notification process 400 using three separate bearer technologies (Push, email, SMS) for notification delivery. The process begins in block 402 whereby a scheduled job on the server is started to check the datastore for events that have not been satisfied on time. If such events are identified, block 404 shows their corresponding escalation contact information, as discussed above with respect to FIG. 3 block 320, and the escalation contact information is then retrieved from the datastore to determine how notifications should be sent. The next step in the process is a determination of what type of notification should be sent, as indicated by the decision block 406. Potential options include Push Notification, Email, or Text Message (SMS) and potentially other notification methods as dictated by wearable devices. Each potential course of action following decision block 406 is described below. It should be noted that this range of options is not exhaustive, and other bearer options may be used.

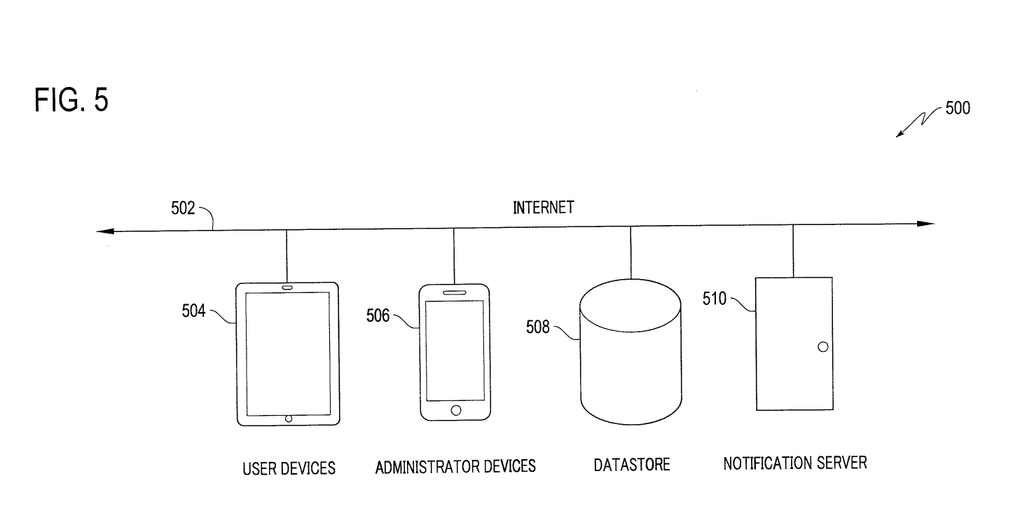

If it is determined at decision block 406 that the notification should be sent via push notification, directly to the app interface of the administrator (primary, and/or secondary and/or tertiary) a push notification is sent as shown in block 408 to that administrator(s) device. If it is determined at decision block 406 that the notification should be sent via Email, directly to the address of the administrator(s) (primary, and/or secondary and/or tertiary) an email message is sent as shown in block 410 to those administrator(s) as have been set up in the escalation procedure by the primary administrator as mentioned in FIG. 3 block 320. If it is determined at decision block 406 that the notification should be sent via text message (SMS), directly to the mobile device of the administrator(s) (primary, and/or secondary and/or tertiary) a text message (SMS) is sent as shown in block 412 to those administrator(s) as have been set up in the escalation procedure by the primary administrator as mentioned in FIG. 3 block 320. This process is automated and requires no instigation from either the user or administrators to invoke, other than the initial setup preferences for notifications already referred to in FIG. 3 block 320. The process is carried out between most of the hardware elements mentioned in FIG. 5, namely, user and administrator devices, and a Push notification server over which the bearer technology is provided.

FIG. 5 is a block schematic diagram of an example of a system for a wellbeing monitoring service in accordance with the disclosed embodiments. The diagram 500 defines the system overview showing the hardware elements and network connectivity that make up the complete system. A central network 502 defines the internet connectivity that supports communications between various hardware components including any number of user devices 504 (e.g., phone, tablet, or wearable device), administrator devices 506, the datastore 508 and Push notification server 510. Devices can connect to the network via wifi or cell service connectivity according to the user and administrator's preferences or connectivity available. All data paths go back and forth along the network between their respective hardware elements as dictated by the processes they are carrying out.

What is claimed is:

1. A method of monitoring a monitored user, the method comprising:
providing a software application which is accessible by the monitored user on a user computing device and a monitoring user on an administrator computing device, wherein the user computing device and the administrator computing device communicate over a common network;
scheduling an event that is displayed on the user computing device; and
providing an alert on the administrator computing device after a first predetermined time period in response to the user computing device not receiving a user input signaling that the scheduled event is completed.

2. The method of claim 1, wherein the alert is a phone call, a Push notification, an email, or an SMS message.

3. The method of claim 1, wherein the user computing device and the administrator computing device are each a computer, a tablet, a phone, or a wearable device.

4. The method of claim 1, wherein the common network is a cloud network.

5. The method of claim 1, wherein the event displayed on the user computing device requires the user to confirm one of the following statuses:
the user is awake and out of bed,
the user has taken their medication, or
the user has completed their daily exercise,
whereby the status is confirmed when the user input is received by the user computing device.

6. The method of claim 1, further comprising sending an escalation notification to a designated individual after a second predetermined time period in response to the user computing device not receiving the user input.

7. A method of monitoring a plurality of monitored users, the method comprising:
providing a software application which is accessible by the plurality of monitored users on a corresponding plurality of user computing devices and by a monitoring user on a administrator computing device, wherein the user computing devices and the administrator computing device are connected to a common network;
scheduling at least one event that is displayed on a corresponding user computing device, the at least one event having a scheduled completion time, whereby the at least one event is completed when a user input is received on the corresponding user computing device;
storing the at least one event and the user input in a datastore as a scheduled event;
periodically checking the datastore for scheduled events that have not been completed by the scheduled completion time; and
providing an alert on the administrator computing device upon identification of at least one scheduled event that has not been completed by the scheduled completion time.

8. The method of claim 7, wherein the alert is a phone call, a Push notification, an email, or an SMS message.

9. The method of claim 7, wherein the user computing devices and the administrator computing device are each a computer, a tablet, a phone, or a wearable device.

10. The method of claim 7, wherein the common network is a cloud network.

11. The method of claim 7, wherein the event displayed on the corresponding user computing device requires the corresponding user to confirm one of the following statuses:
the corresponding user is awake and out of bed,
the corresponding user has taken their medication, or
the corresponding user has completed their daily exercise,
whereby the status is confirmed when the user input is received by the corresponding user computing device.

12. The method of claim 7, further comprising sending an escalation notification to a designated individual at a predetermined time after identification of the at least one scheduled event that has not been completed by the scheduled completion time.

13. A system comprising:
a user display interface configured to display a scheduled event and receive a user input signaling that the scheduled event is completed;
an administrator display interface remote from the user display interface and configured to receive an alert when the user input is not received by the user display interface by a first predetermined time,
wherein the user display interface and the administrator display interface are in communication over a common network.

14. The system of claim 13, wherein the alert is a phone call, a Push notification, an email, or an SMS message.

15. The system of claim 13, wherein the user display interface and the administrator display interface are each a computer, a tablet, a phone, or a wearable device.

16. The system of claim 13, wherein the common network is a cloud network.

17. The system of claim 13, wherein the scheduled event displayed on the user display interface requires a user to confirm one of the following statuses:
the user is awake and out of bed,
the user has taken their medication, or
the user has completed their daily exercise,
whereby the status is confirmed when the user input is received by the user display interface.

18. The system of claim 13, wherein the administrator display interface is configured to send an escalation notification to a designated individual when the user input is not received by the user display interface by a second predetermined time.

19. The system of claim 13, further comprising a datastore.

20. The system of claim 13, wherein:
the user display interface is configured to receive a user input signaling that the scheduled event is not completed, and to display the scheduled event at a later time after receiving the user input signaling that the scheduled event is not completed.
